(19) United States
(12) Patent Application Publication
(10) Pub. No.: US 2018/0034146 A1
(43) Pub. Date: Feb. 1, 2018

(54) Antenna Device

(71) Applicant: Trans Electric Co., Ltd., Changhua (TW)

(72) Inventor: Ken Chiang, Changhua (TW)

(21) Appl. No.: 15/368,968

(22) Filed: Dec. 5, 2016

(30) Foreign Application Priority Data
Jul. 29, 2016 (TW) 105211494

(51) Int. Cl. H01Q 1/42; H01Q 1/38

(52) U.S. Cl. CPC H01Q 1/42; H01Q 1/38

(57) ABSTRACT

An antenna device includes a housing unit and an antenna unit. The housing unit includes a primary housing, and two secondary housings respectively and removably connected to opposite ends of the primary housing. The antenna unit includes a primary antenna module and two secondary antenna modules disposed respectively in the primary housing and secondary housings. The primary antenna module includes a circuit board, at least one first coupling portion disposed on the circuit board, and at least one second coupling portion disposed on the circuit board. The secondary antenna modules include at least one signal contact connected removably to a respective one of the at least one first coupling portion and the at least one second coupling portion.

### CROSS-REFERENCE TO RELATED APPLICATION

This application claims priority of Taiwanese Patent Application No. 105211494, filed on Jul. 29, 2016.

### FIELD

The disclosure relates to an antenna device, and more particularly to an antenna device with a removable antenna module.

### BACKGROUND

Recent trends in use of radio frequencies for broadcasting are transitioning from Very High Frequency (VHF) to Ultra High Frequency (UHF). In the interim, a conventional antenna is designed for operating with ultra wideband so as to receive signals in both VHF and UHF bands. However, quality of signal reception in an individual one of the operating bands of the conventional antenna is not as good as that of a single-band antenna, which is designed exclusively for operating in one of the abovementioned bands. The deficiency of performance will become more apparent especially in a future broadcasting environment where UHF antennas are prevailing. However, since replacement of the conventional antenna is expensive and time-consuming, consumers may refrain from upgrading the conventional antenna in the future broadcasting environment.

### SUMMARY

Therefore, an object of the disclosure is to provide an antenna device that can alleviate at least one of the drawbacks of the prior art.

Accordingly, an antenna device includes a housing unit and an antenna unit. The housing unit includes a primary housing and two secondary housings. The primary housing defines a primary housing space and extends along an axis. The secondary housings are respectively and removably connected to opposite ends of the primary housing along the axis. Each of the secondary housings defines a secondary housing space. The antenna unit includes a primary antenna module and two secondary antenna modules. The primary antenna module is disposed in the primary housing space and includes a circuit board, at least one first coupling portion disposed at an end of the circuit board, and at least one second coupling portion disposed at an opposite end of the circuit board along the axis. Each of the secondary antenna modules is disposed in the secondary housing space of a respective one of the secondary housings, and includes at least one signal contact that is connected electrically and removably to a respective one of the at least one first coupling portion and the at least one second coupling portion.

### BRIEF DESCRIPTION OF THE DRAWINGS

Other features and advantages of the disclosure will become apparent in the following detailed description of the embodiment with reference to the accompanying drawings, of which:

FIG. 1 is a partly exploded perspective view illustrating an embodiment of an antenna device according to the disclosure; and

FIG. 2 is an exploded perspective view of a primary housing and a primary antenna module of the embodiment.

### DETAILED DESCRIPTION

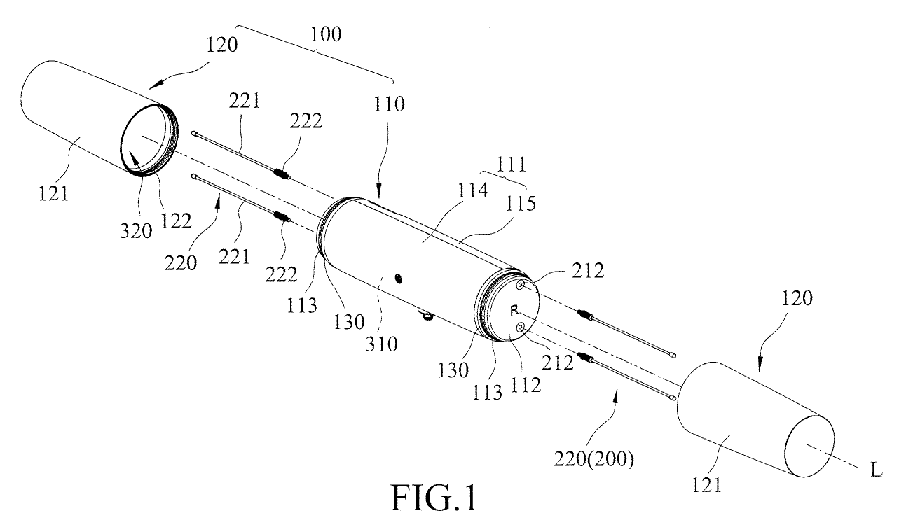

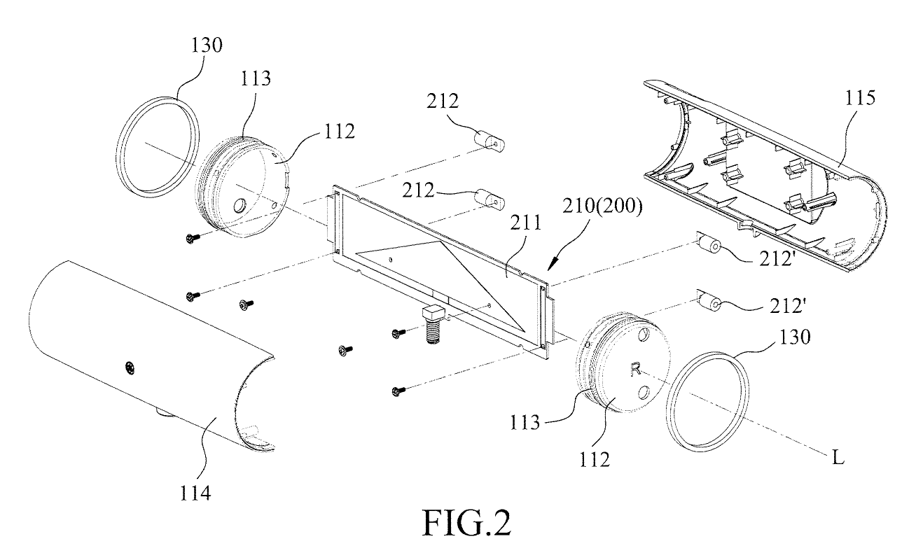

Referring to FIGS. 1 and 2, an embodiment of an antenna device according to the disclosure is illustrated. The antenna device includes a housing unit 100 and an antenna unit 200.

The housing unit 100 includes a primary housing 110, two secondary housings 120, and two isolating spacers 130.

The primary housing 110 defines a primary housing space 310, extends along an axis (L), and includes a surrounding wall 111 that surrounds the axis (L), and two end covers 112 that are disposed respectively at opposite ends of the primary housing 110 and that are connected respectively at opposite ends of the surrounding wall 111 along the axis (L). The surrounding wall 111 includes a first half segment 114 and a second half segment 115 that are disposed at opposite sides of the axis (L) and that are separately connected together. The end covers 112 cooperate with the first half segment 114 and the second half segment 115 to define the primary housing space 310. Moreover, each of the end covers 112 has a first connecting portion 113 surrounding the axis (L) and formed on an external surface thereof. It should be noted that the primary housing 110 is not limited to the above-mentioned implementation of this disclosure. The first and second half segments 114, 115 may be formed as one piece, and the primary housing 110 may be prismatic in shape. Also, each of the end covers 112 may have two semicircular portions (not shown) that are respectively connected to the first half segment 114 and the second half segment 115. The primary housing 110 has a relatively simple structure and is easy to assemble.

The secondary housings 120 are respectively and removably connected to the opposite ends of the primary housing 110 along the axis (L). Each of the secondary housings 120 has a housing wall 121 defining a secondary housing space 320 (only one is visible in FIG. 1), and has a second connecting portion 122 that is formed on an internal surface of the housing wall 121 and that is connected separably to the first connecting portion 113 of a respective one of the end covers 112. In this embodiment, the connection between each first connecting portion 113 and a corresponding second connecting portion 122 is implemented by virtue of threaded structure. However, in other embodiments, the connection may be implemented by virtue of, but not be limited to, latch structure or fitted engagement with friction.

The isolating spacers 130 are respectively sleeved on the opposite ends of the primary housing 110. Each of the isolating spacers 130 is located between and tightly pressed by the primary housing 110 and a respective one of the secondary housings 120 for isolating the secondary housing space 320 of the respective one of the secondary housings 120 from the external environment. Therefore, vapor and dust is prevented from entering the secondary housing space 320 of each of the secondary housings 120 and damaging components therein.

The antenna unit 200 includes a primary antenna module 210 and two secondary antenna modules 220.

The primary antenna module 210 is disposed in the primary housing space 310 between the first half segment 114 and the second half segment 115. In this embodiment, the primary antenna module 210 includes a circuit board 211 extending along the axis (L). The circuit board 200 has two corners at an end thereof, and two corners at an opposite end thereof along the axis (L). The primary antenna module 210 further includes two first coupling portions 212 formed respectively at the two corners of the end of the circuit board 200 and spaced apart from each other, and two second coupling portions 212′ formed respectively at the two corners of the opposite end of the circuit board 200 along the axis (L) and spaced apart from each other.

It should be noted that in this embodiment, the first coupling portions 212 extend through one of the end covers 112, and the second coupling portions 212′ extend through the other one of the end covers 112. In addition, each of the secondary antenna modules 220 is disposed in the secondary housing space 320 of a respective one of the secondary housings 120, and includes two antenna rods 221 extending parallel to the axis (L), and two signal contacts 222. Each of the signal contacts 222 of one of the secondary antenna modules 220 is formed at an end of a respective one of the antenna rods 221 of the one of the secondary antenna modules 220, and is connected electrically and removably to a respective one of the first coupling portions 212. Each of the signal contacts 222 of the other one of the secondary antenna modules 220 is formed at an end of a respective one of the antenna rods 221 of the other one of the secondary antenna modules 220, and is connected electrically and removably to a respective one of the second coupling portions 212′. The antenna rods 221 are made of metal. By connecting the primary antenna module 210 and the secondary antenna modules 220, bandwidth of the antenna device is broadened. It is worth noting that the implementation of the secondary antenna modules 220 is not limited to the above-mentioned embodiment. In other embodiments, the secondary antenna modules 220 may be implemented by a Flexible Printed Circuit (FPC), or by a telescopic antenna. Depending on different implementations of the secondary antenna modules 220, the implementation of the signal contacts 222 would accordingly vary. Since the implementation of the signal contacts 222 is already known to a skilled person in the art, details thereof will be omitted for the sake of brevity. Additionally, while in this embodiment, each of the secondary antenna modules 220 includes two antenna rods 221, the number of the antenna rods 221 may vary (e.g., one or three antenna rods 221) in other embodiments. Depending on the number of the antenna rods 221, the number of the first and second coupling portions 212, 212′ would accordingly vary so as to be respectively connected to the antenna rods 221.

Based on the antenna theory, for each of the secondary antenna modules 220, the antenna rods 221 are parallel to the axis (L) and are spaced apart from each other to result in a substantially ideal radiation field.

According to the disclosure, without being connected with the secondary antenna modules 220, the primary antenna module 210 is operable with radio frequencies in the range between 400 MHz and 800 MHz, which corresponds to the Ultra High Frequency (UHF) band that would be prevailingly utilized by digital televisions in the future. Comparatively, a combination of the primary antenna module 210 and the secondary antenna module 220 is operable with radio frequencies in the range between 150 MHz and 800 MHz, which covers the Very High Frequency (VHF) band and the UHF band and is widely utilized by current digital televisions.

In summary, the antenna device according to the disclosure has the following advantages. First, the combination of the primary antenna module 210 and the secondary antenna module 220 is operable in the VHF band and the UHF band, which meets requirements of the current broadcasting environment. In the future, when using the UHF band becomes the mainstream, a user could use the primary antenna module 210 alone with the secondary antenna module 220 being removed. Therefore, the user does not have to buy a new antenna to replace an existing antenna. Moreover, reuse of the antenna device is beneficial to environmental protection. Second, since the secondary housings 120 and the antenna rods 221 can be separated from the primary housing 110, the volume of the antenna device can be reduced. Therefore, efficiency of packaging, stacking, storage and transportation of the antenna device is thereby improved. Consequently, cost of the antenna device is reduced.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. An antenna device comprising:
a housing unit including
a primary housing that defines a primary housing space, and that extends along an axis, and
two secondary housings that are respectively and removably connected to opposite ends of said primary housing along the axis, each of said secondary housings defining a secondary housing space; and
an antenna unit including
a primary antenna module that is disposed in the primary housing space and that includes
a circuit board,
at least one first coupling portion disposed at an end of said circuit board, and
at least one second coupling portion disposed at an opposite end of said circuit board along the axis, and
two secondary antenna modules, each of which is disposed in said secondary housing space of a respective one of said secondary housings, and includes at least one signal contact that is connected electrically and removably to a respective one of said at least one first coupling portion and said at least one second coupling portion.

2. The antenna device as claimed in claim 1, wherein each of said secondary antenna modules includes at least one antenna rod extending parallel to the axis, said at least one signal contact being formed at an end of said at least one antenna rod.

3. The antenna device as claimed in claim 2, wherein:
said primary antenna module includes a plurality of said first coupling portions spaced apart from each other, and a plurality of said second coupling portions spaced apart from each other;
one of said secondary antenna modules includes a plurality of said antenna rods and a plurality of said signal contacts, each of said signal contacts being formed at an end of a respective one of said antenna rods and connected electrically and removably to a respective one of said first coupling portions; and
the other one of said secondary antenna modules includes a plurality of said antenna rods and a plurality of said signal contacts, each of said signal contacts being formed at an end of a respective one of said antenna rods and connected electrically and removably to a respective one of said second coupling portions.

4. The antenna device as claimed in claim 2, wherein:
said circuit board has two corners at said end thereof, and two corners at said opposite end thereof;
said primary antenna module includes two of said first coupling portions spaced apart from each other, and two of said second coupling portions spaced apart from each other, said first and second coupling portions being formed respectively at said corners of said circuit board; and
each of said secondary antenna modules includes two of said antenna rods.

5. The antenna device as claimed in claim 1, wherein said primary housing includes
a surrounding wall surrounding the axis, and
two end covers disposed respectively at said opposite ends of said primary housing, connected respectively at opposite ends of said surrounding wall along the axis, and cooperating with said surrounding wall to define said primary housing space, said at least one first coupling portion and said at least one second coupling portion extending respectively through said end covers.

6. The antenna device as claimed in claim 5, wherein said surrounding wall includes a first half segment and a second half segment that are disposed at opposite sides of the axis and that are separately connected together.

7. The antenna device as claimed in claim 5, wherein:
each of said end covers has a first connecting portion; and
each of said secondary housings has a second connecting portion connected separably to said first connecting portion of a respective one of said end covers.

8. The antenna device as claimed in claim 5, wherein:
each of said end covers has a first connecting portion surrounding the axis and formed on an external surface thereof; and
each of said secondary housings has a housing wall defining said secondary housing space, and a second connecting portion formed on an internal surface of said housing wall, and connected separably to said first connecting portion of a respective one of said end covers.

9. The antenna device as claimed in claim 1, wherein said housing unit further includes two isolating spacers respectively sleeved on said opposite ends of said primary housing, each of said isolating spacers being located between and tightly pressed by said primary housing and a respective one of said secondary housings for isolating said secondary housing space of the respective one of said secondary housings from the external environment.

10. The antenna device as claimed in claim 1, wherein:
said primary antenna module is operable with radio frequencies in the range between 400 MHz and 800 MHz; and
a combination of said primary antenna module and said secondary antenna module is operable with radio frequencies in the range between 150 MHz and 800 MHz.
